(19) United States
(12) Patent Application Publication
(10) Pub. No.: US 2023/0410506 A1
(43) Pub. Date: Dec. 21, 2023

(54) ANALYSIS APPARATUS, SYSTEM, METHOD, AND NON-TRANSITORY COMPUTER READABLE MEDIUM STORING PROGRAM

(71) Applicant: NEC Corporation, Minato-ku, Tokyo (JP)

(72) Inventors: Shin NORIEDA, Tokyo (JP); Yoshiyuki TANAKA, Tokyo (JP); Shogo AKASAKI, Tokyo (JP); Haruki Yokota, Tokyo (JP); Masami SAKAGUCHI, Tokyo (JP)

(73) Assignee: NEC Corporation, Minato-ku, Tokyo (JP)

(21) Appl. No.: 18/030,422

(22) PCT Filed: Oct. 12, 2020
(86) PCT No.: PCT/JP2020/038511

§ 371 Date: Apr. 5, 2023

(51) Int. Cl. G06V 20/40; G06V 40/16

(52) U.S. Cl. CPC G06V 20/41; G06V 20/49; G06V 40/174

(57) ABSTRACT

An analysis apparatus (100) includes: emotion data acquisition means (111) for acquiring emotion data that includes time data, the emotion data being generated based on face image data of participants in an online meeting; meeting data acquisition means (112) for acquiring meeting data including image data that includes time data in the meeting; analysis data generation means (113) for generating analysis data regarding the meeting based on the emotion data; screen generation means (114) for generating a playback screen including a seek bar for specifying a time, the analysis data that corresponds to the specified time, and the image data; and output means (115) for outputting the playback screen.

### TECHNICAL FIELD

The present invention relates to an analysis apparatus, a system, a method, and a program.

### BACKGROUND ART

While an online meeting is being held, it is difficult to know what the atmosphere of the online meeting is. Patent Literature 1 discloses a technique for detecting an emotion of a person included in an image to be displayed on a screen.

### CITATION LIST

### Patent Literature

### [Patent Literature 1] Japanese Unexamined Patent Application Publication No. 2018-088655

### SUMMARY OF INVENTION

### Technical Problem

In Patent Literature 1, however, it is impossible to detect emotions of a plurality of participants who participate in a meeting. Therefore, there is problem that it is difficult to know what the emotions of the participants in the online meeting are.

The present disclosure has been made in view of the aforementioned problem and an aim of the present disclosure is to provide an analysis apparatus, a system, a method, and a program capable of knowing emotions of participants in an online meeting.

### Solution to Problem

An analysis apparatus according to the present disclosure includes: emotion data acquisition means for acquiring emotion data that includes time data, the emotion data being generated based on face image data of participants in an online meeting; meeting data acquisition means for acquiring meeting data including image data that includes time data in the meeting; analysis data generation means for generating analysis data regarding the meeting based on the emotion data; screen generation means for generating a playback screen including a seek bar for specifying a time, the analysis data that corresponds to the specified time, and the image data; and output means for outputting the playback screen.

A method according to the present disclosure includes: acquiring emotion data that includes time data, the emotion data being generated based on face image data of participants in an online meeting; acquiring meeting data including image data that includes time data in the meeting; generating analysis data regarding the meeting based on the emotion data; generating a playback screen including a seek bar for specifying a time, the analysis data that corresponds to the specified time, and the image data; and outputting the playback screen.

A non-transitory computer readable medium according to the present disclosure causes a computer to execute the following steps. The computer stores a program for causing the computer to execute the processing of: acquiring emotion data that includes time data, the emotion data being generated based on face image data of participants in an online meeting; acquiring meeting data including image data that includes time data in the meeting; generating analysis data regarding the meeting based on the emotion data; generating a playback screen including a seek bar for specifying a time, the analysis data that corresponds to the specified time, and the image data; and outputting the playback screen.

### Advantageous Effects of Invention

According to the present disclosure, it is possible to provide an analysis apparatus, an analysis method, an analysis system, and a program capable of knowing emotions of participants in an online meeting.

### BRIEF DESCRIPTION OF DRAWINGS

FIG. 1 is a block diagram showing a configuration of an analysis apparatus according to a first example embodiment;

FIG. 2 is a flowchart showing an operation of the analysis apparatus according to the first example embodiment;

FIG. 3 is a diagram showing an example of a playback screen according to the first example embodiment;

FIG. 4 is a block diagram showing a configuration of an analysis system according to a second example embodiment;

FIG. 5 is a block diagram showing a configuration of an analysis apparatus according to the second example embodiment;

FIG. 6 is a diagram showing an example of data processed by an analysis data generation unit according to the second example embodiment;

FIG. 7 is a block diagram showing a configuration of an emotion data generation apparatus according to the second example embodiment;

FIG. 8 is a flowchart showing an operation of the analysis apparatus according to the second example embodiment;

FIG. 9 is a diagram showing a first example of a playback screen according to the second example embodiment;

FIG. 10 is a diagram showing a second example of the playback screen according to the second example embodiment; and

FIG. 11 is a block diagram illustrating a hardware configuration of a computer.

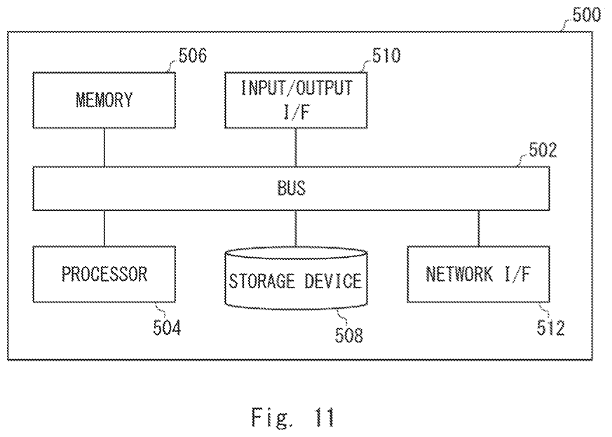

### EXAMPLE EMBODIMENT

In the following, with reference to the drawings, example embodiments of the present disclosure will be described in detail. Throughout the drawings, the same or corresponding elements are denoted by the same reference symbols and overlapping descriptions will be omitted as necessary for the sake of clarification of the description.

In the following example embodiments, the term “online meeting” means any meeting that is held using a plurality of meeting terminals connected to one another via a communication line in such a way that these meeting terminals can communicate with one another. The meeting terminal connected to the online meeting may be, for example, a personal computer, a smartphone, a tablet terminal, or a mobile phone equipped with a camera. Further, the meeting terminal is not limited to the aforementioned ones as long as it is an apparatus including a camera that captures images of participants, a microphone that collects speeches of the participants, and a communication function that transmits and receives image data or voice data. In the following description, the online meeting may be simply referred to as a “meeting”.

The participants of the online meeting in the following example embodiments indicate persons who access the online meeting via the meeting terminals and include the host of the meeting, speakers or presenters of the meeting, and observers of the meeting. When, for example, a plurality of persons participate in the meeting via one meeting terminal, each of these plurality of persons is a participant. In this example embodiment, it is assumed that the participants participate in the meeting in a state in which their face images can be captured by cameras included in the meeting terminals or connected to the meeting terminals.

### First Example Embodiment

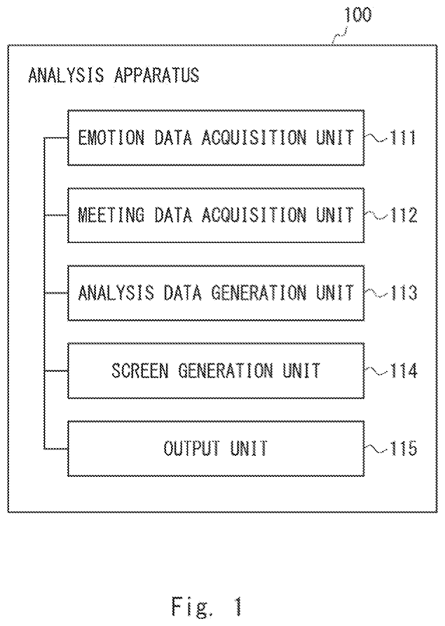

Referring first to FIG. 1, a configuration of an analysis apparatus 100 according to a first example embodiment will be described. FIG. 1 is a block diagram showing a configuration of the analysis apparatus according to the first example embodiment. The analysis apparatus 100 acquires emotion data of participants who participate in an online meeting, generates analysis data related to this online meeting from the acquired emotion data, and outputs the generated analysis data to a predetermined terminal or the like.

The analysis apparatus 100 is connected to each of an emotion data generation apparatus 300 (described later) that generates emotion data of the participants in the online meeting and a meeting management apparatus 400 (described later) that manages the meeting in such a way that the analysis apparatus 100 can communicate with the emotion data generation apparatus 300 and the meeting management apparatus 400. Further, the analysis apparatus 100 is connected to a terminal (user terminal) that the user who uses the analysis apparatus 100 has in such a way that the analysis apparatus 100 can communicate with the terminal. The analysis apparatus 100 includes an emotion data acquisition unit 111, a meeting data acquisition unit 112, an analysis data generation unit 113, a screen generation unit 114, and an output unit 115.

The emotion data acquisition unit 111 acquires emotion data that includes time data from the emotion data generation apparatus 300. The emotion data generation apparatus 300 generates emotion data from the face image data of the participants during the online meeting and supplies the generated emotion data to the analysis apparatus 100. The emotion data is data indicating the emotion that each of the participants in the meeting has.

The emotion data includes, for example, at least one index (first index) such as a level of attention, a level of confusion, a level of happiness, surprise and the like. That is, the emotion data shows the extent to which the participant is feeling these kinds of emotions (the state of the emotion) for each of the aforementioned indices. The emotion data indicates at least one index by a numerical value.

The emotion data generation apparatus 300 generates emotion data for each predetermined period (e.g., one second). The emotion data acquisition unit 111 acquires emotion data for each predetermined time along a proceeding time of the meeting. Upon acquiring the emotion data, the emotion data acquisition unit 111 supplies the acquired emotion data to the analysis data generation unit 113.

The meeting data acquisition unit 112 acquires meeting data from the meeting management apparatus 400. The meeting management apparatus 400 is, for example, a server apparatus that each of the participants in the meeting accesses in such a way that they can communicate with each other. The meeting management apparatus 400 may be the one included in a meeting terminal 900 (described later) used by the participant of the meeting. The meeting data includes image data that involves time data of the participants in the meeting. The image data may be data regarding a screen of the speaker in the meeting, a screen of a non-speaker in the meeting, and a screen shared in the meeting. Then the meeting data acquisition unit 112 supplies the meeting data to the analysis data generation unit 113.

The analysis data generation unit 113 generates analysis data regarding the meeting based on the emotion data acquired by the emotion data acquisition unit 111. The analysis data includes at least one index (second index) indicating reactions of the participant to the meeting, such as a level of attention, a level of empathy, a level of understanding and the like. The analysis data generation unit 113 indicates at least one second index indicating the reactions of the participant to the meeting by a numerical value based on emotion data. The analysis data generation unit 113 generates, for example, a time-series graph showing a temporal transition of the numerical value in the second index as analysis data. Accordingly, it is possible to indicate detailed changes in the reactions of the participant to the meeting. The analysis data generation unit 113 supplies the generated analysis data to the screen generation unit 114.

The screen generation unit 114 generates a playback screen including a seek bar for specifying a time, the analysis data at the time specified by the seek bar, and the image data. The screen generation unit 114 extracts the image data of the time specified by the seek bar based on the image data and the time data that is included in the image data, and includes the extracted image data in the playback screen. The screen generation unit 114 further generates a playback screen including a display for identifying a numerical value in the second index that corresponds to the time specified by the seek bar on a time-series graph. The screen generation unit 114 generates, for example, an axis that corresponds to the time specified in the seek bar on the time-series graph. The axis generated on the time-series graph indicates the second index at the specified time.

The output unit 115 outputs the playback screen generated by the screen generation unit 114 to a user terminal 990 (described later). The user who uses the analysis apparatus 100 visually recognizes the playback screen output to the user terminal 990. Accordingly, the user concurrently perceives the analysis data displayed on the playback screen and the meeting image. The user is therefore able to recognize the situation of the meeting and the emotions of the participants in this situation.

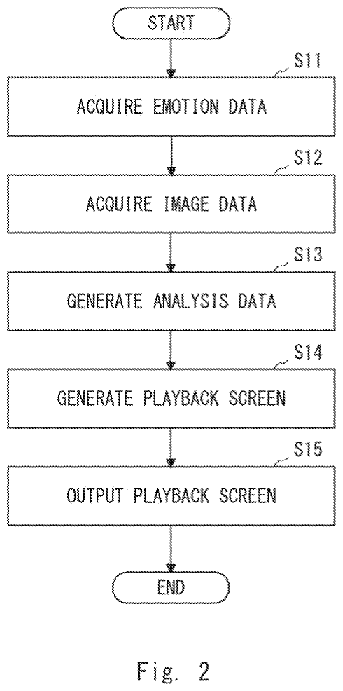

Referring next to FIG. 2, an operation of the analysis apparatus 100 according to the first example embodiment will be described. FIG. 2 is a flowchart showing an operation of the analysis apparatus 100 according to the first example embodiment. The flowchart shown in FIG. 2 is started when, for example, the analysis apparatus 100 receives a signal indicating that the meeting has been started from the meeting management apparatus 400.

First, the emotion data acquisition unit 111 acquires emotion data that includes time data, the emotion data being generated based on face image data of a participant in an online meeting (Step S11). Next, the meeting data acquisition unit 112 acquires meeting data including image data that includes time data in the meeting (Step S12). The analysis data generation unit 113 generates analysis data regarding the meeting based on the emotion data (Step S13). The screen generation unit 114 generates a playback screen including a seek bar for specifying a time, analysis data at the time specified by the seek bar, and image data (Step S14). Next, the output unit 115 outputs the generated playback screen (Step S15).

In the aforementioned processing, either Step S11 or Step S12 may be performed first. Further, Step S11 and Step S12 may be executed in parallel to each other. Alternatively, Step S11 and Step S12 may be alternately executed for each predetermined period.

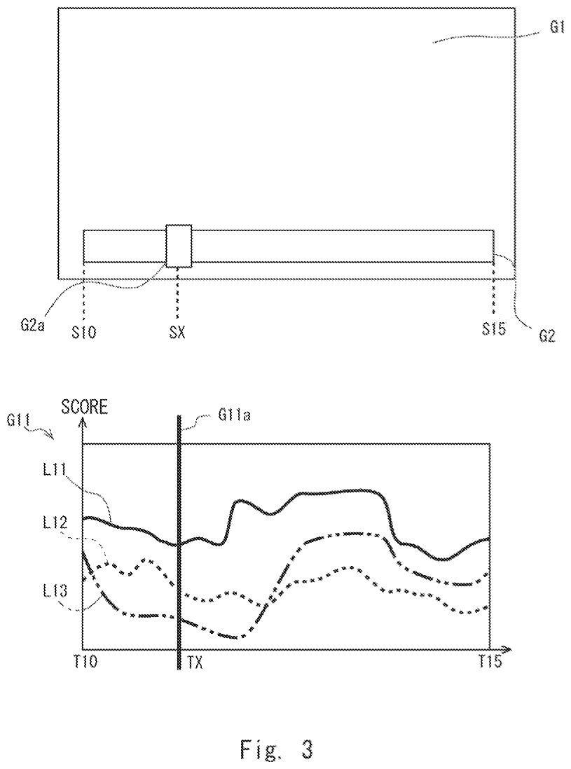

Referring next to FIG. 3, an example of the playback screen according to the first example embodiment will be described. FIG. 3 is a diagram showing one example of the playback screen according to the first example embodiment.

Image data G1, which is image data in the meeting, is image data in a time specified by a seek bar G2 that will be described later. The seek bar is superimposed on the image data G1.

The seek bar G2 is an interface for specifying a specific time in the meeting and displaying the specified time. The seek bar G2 is a strip-shaped image that is extended in the right/left direction and is superimposed, for example, on the meeting screen.

The seek bar G2 includes a slider G2a. The slider G2a is a rectangular image disposed on the seek bar G2 and specifies a specific position in the seek bar. The user is able to specify the position of the slider G2a by selecting a specific position of the seek bar G2. Accordingly, an image of the time that corresponds to the position specified by the slider G2a is displayed in the image data G1. The user is also able to specify the position of the slider G2a by moving the slider G2a in the right/left direction in a state in which the slider G2a is selected.

The graph G11 is a time-series graph showing a temporal transition of the second index. In the graph G11, the horizontal axis indicates time and the vertical axis indicates the numerical value (score) in the second index. The left end of the horizontal axis is time T10, the time elapses as it moves to the right, and the right end is time T15. The time T10 corresponds to the start time of the meeting and time T15 corresponds to the end time of the meeting.

Further, in the graph G11, first analysis data L11 shown by a solid line, second analysis data L12 shown by a dotted line, and third analysis data L13 shown by an alternate long and two short dashes lines are plotted. The second index is, for example, the level of attention, the level of empathy, or the level of understanding. The first analysis data L11 indicates the level of attention. The second analysis data L12 indicates the level of empathy. The third analysis data L13 indicates the level of understanding.

An axis G11a, which is a linear display that is extended in the vertical direction, crossing the horizontal axis of the graph G11, indicates a specific time in the graph G11. The axis G11a moves on the horizontal axis of the graph G11 and shows time TX specified by the seek bar G2. That is, the position of the seek bar G2 and the position of the axis G11a are associated with each other. The seek bar G2 and the axis G11a may be the ones displayed by color tones in accordance with the value of the analysis data in the specified position. Accordingly, the analysis apparatus 100 is able to qualitatively show the state of the emotion at the time specified in the meeting image. The user is therefore able to intuitively know the state of the emotion at a specific time.

In this example, a position S10 of the seek bar G2 in the left end corresponds to time T11 and a position S15 of the seek bar G2 in the right end corresponds to time T15. The relative right/left position of the slider G2a in the seek bar G2 is set so as to correspond to the relative right/left position of the axis Glia in the graph G11. When, for example, the slider G2a is present in a position SX, the axis G11a crosses the time TX indicated in the horizontal axis in the graph G11. At this time, the ratio of the length from the position SX to the position S10 to the length from the position S15 to the position SX is the same as the ratio of the length from time TX to time T10 to the length from time T15 to time TX. When the user moves the position of the slider G2a, the position of the axis G11a also moves along with the movement of the position of the slider G2a. When the user moves the position of the axis G11a, the position of the slider G2a may move along with the movement of the position of the axis G11a.

The user is able to move the position of the slider G2a on the playback screen output by the output unit 115. Upon detecting the movement of the position of the slider G2a, the analysis apparatus 100 detects the time specified by the seek bar G2 based on the relative right/left position of the slider G2a after the movement. The screen generation unit 114 generates a playback screen including the image data G1 based on the detected time. Then the screen generation unit 114 generates a playback screen including the axis G11a in which the relative right/left position is determined on the graph G11 based on the detected time. The output unit 115 then outputs the generated playback screen.

Further, the user is able to move the position of the axis G11a in the graph G11 on the playback screen output by the output unit 115. Upon detecting the movement of the position of the axis G11a, the analysis apparatus 100 detects the time specified by the axis G11a based on the relative right/left position of the axis G11a after the movement. The screen generation unit 114 generates a playback screen including the image data G1 based on the detected time. Then the screen generation unit 114 generates a playback screen including the seek bar G2 in which the relative right/left position of the slider G2a is determined based on the detected time. The output unit 115 then outputs the generated playback screen.

In the analysis apparatus 100 according to the first example embodiment, the user is able to check the image data at a desired timing of the meeting by moving the slider G2a of a seek bar G3 on the playback screen. The position of the axis G11a in the horizontal axis of the graph G11 corresponds to the time specified by the seek bar G3. The user is therefore able to instantly know the tendency of the emotions of the participants in the meeting at the timing when the image data in the meeting is checked by checking the position of the axis G11a in the graph G11. Therefore, the analysis apparatus 100 is able to know what the emotions of the participants in the meeting are.

### Second Example Embodiment

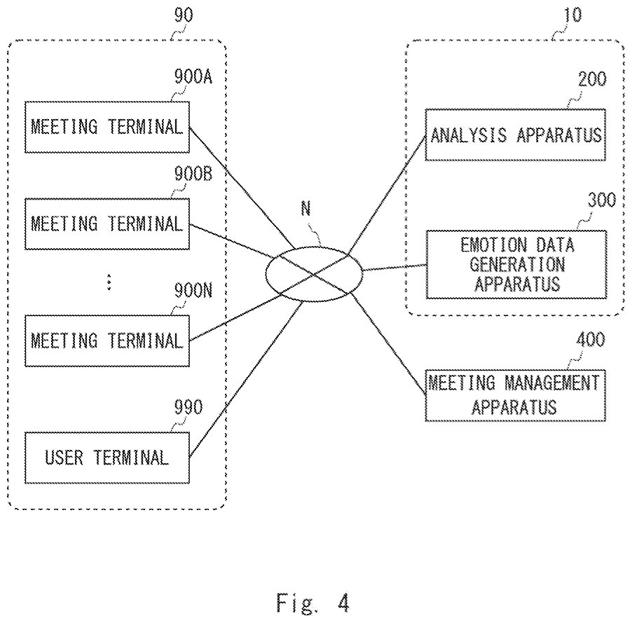

Referring first to FIG. 4, a configuration of an analysis system 10 according to a second example embodiment will be described. FIG. 4 is a block diagram showing the configuration of the analysis system 10 according to the second example embodiment.

As shown in FIG. 4, the analysis system 10 includes an analysis apparatus 200 and an emotion data generation apparatus 300. The analysis apparatus 200 and the emotion data generation apparatus 300 are connected to each other via a network N in such a way that they can communicate with each other. Further, the analysis system 10 is connected to a meeting management apparatus 400 via the network N in such a way that the analysis system 10 can communicate with the meeting management apparatus 400. The meeting management apparatus 400 is connected to a meeting terminal group 90 via the network N and manages an online meeting. The meeting terminal group 90 includes a plurality of meeting terminals (900A, 900B, . . . , 900N) and a user terminal 990.

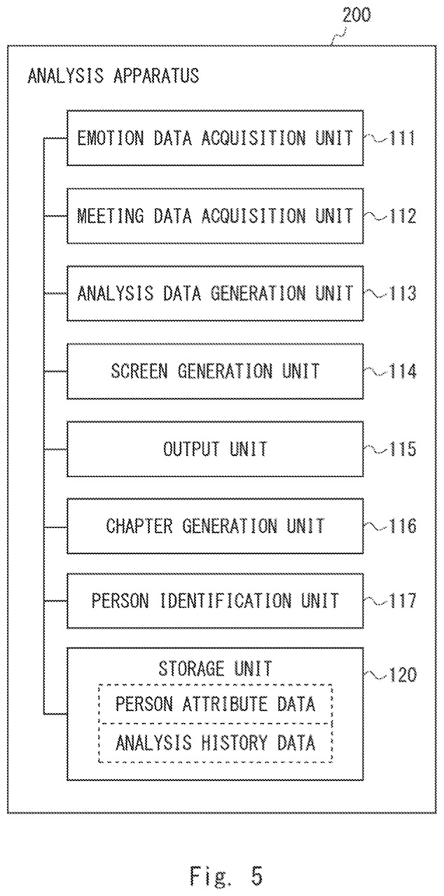

Referring next to FIG. 5, a configuration of the analysis apparatus 200 according to the second example embodiment will be described. FIG. 5 is a block diagram showing the configuration of the analysis apparatus according to the second example embodiment.

As shown in FIG. 5, the analysis apparatus 200 includes an emotion data acquisition unit 111, a meeting data acquisition unit 112, an analysis data generation unit 113, a screen generation unit 114, an output unit 115, a chapter generation unit 116, a person identification unit 117, and a storage unit 120.

The emotion data acquisition unit 111 acquires emotion data that includes time data from the emotion data generation apparatus 300. The emotion data generation apparatus 300 generates emotion data from face image data of the participants during the online meeting and supplies the generated emotion data to the analysis apparatus 100. The emotion data is data showing the emotion that each of the participants in the meeting has.

The emotion data includes, for example, at least one index (first index) such as a level of attention, a level of confusion, a level of happiness, surprise and the like. That is, the emotion data shows the extent to which the participant is feeling these kinds of emotions (the state of the emotion) for each of the aforementioned indices. The emotion data shows at least one index by a numerical value.

The emotion data generation apparatus 300 generates emotion data for each predetermined period (e.g., one second). The emotion data acquisition unit 111 acquires emotion data for each predetermined time along a proceeding time of the meeting. Upon acquiring the emotion data, the emotion data acquisition unit 111 supplies the acquired emotion data to the analysis data generation unit 113.

The meeting data acquisition unit 112 acquires meeting data from the meeting management apparatus 400. The meeting management apparatus 400 is, for example, a server apparatus that each of the participants in the meeting accesses in such a way that communication can be performed between them. The meeting management apparatus 400 may be the one included in a meeting terminal 900 used by the participant of the meeting. The meeting data includes image data that includes time data of the participants in the meeting. The image data may be data regarding a screen of the speaker in the meeting, a screen of a non-speaker in the meeting, and a screen shared in the meeting.

Further, the meeting data includes the start time and the end time of the meeting. Further, the meeting data includes time of breaks taken during the meeting. Further, the meeting data may include, for example, a time when the authority to operate the shared screen shared by the participants (owner of the shared screen) is switched or a time when the speech of the participant is switched. In this case, the meeting data may include a time when a page is forwarded in the shared screen or when a display image is changed. Further, the meeting data may include information indicating what each of the aforementioned times shows. The meeting data acquisition unit 112 supplies the acquired meeting data to the analysis data generation unit 113 and the chapter generation unit 116.

The chapter generation unit 116 generates chapters for the meeting from the meeting data received from the meeting data acquisition unit 112. The chapter generation unit 116 detects, for example, the time from the start of the meeting to the end of the meeting. The chapter generation unit 116 further detects times that match a preset condition and generates data indicating the chapters, each of the times being a break for the next chapter. The chapters in the meeting according to the present disclosure are defined based on whether a state in which the predetermined condition is met has been maintained in the meeting or the predetermined condition has been changed. The chapter generation unit 116 may generate chapters based on, for example, data regarding screen sharing. More specifically, the chapter generation unit 116 may generate a chapter in accordance with the timing when the screen sharing is switched. The chapter generation unit 116 may further generate a chapter in accordance with a time when the owner of the shared screen in the screen sharing is switched. The chapter generation unit 116 supplies the data indicating the generated chapters to the analysis data generation unit 113.

The person identification unit 117 may include a function of extracting the face feature information of the person from the image data and estimating the segmentation to which the person belongs in accordance with the extracted information. The segmentation to which the person belongs indicates, for example, features or attributes of the person such as the age or the sex of the person. The person identification unit 117 identifies the segmentation to which the participant in the meeting belongs based on the image data received from the meeting data acquisition unit 112 using the aforementioned function. The person identification unit 117 supplies the data regarding the segmentation of the person to the analysis data generation unit 113.

The person identification unit 117 may further identify the segmentation to which the identified participant belongs using person attribute data stored in the storage unit 120. In this case, the person identification unit 117 associates the face feature information extracted from the face image with the person attribute information stored in the storage unit 120, and identifies the segmentation of the participant who corresponds to the face feature information. The segmentation of the participant here is, for example, the legal entity to which the participant belongs, the department in the legal entity, the category of the job or the like of the participant. According to this configuration, the analysis apparatus 200 is able to extract data that can be used for the analysis data while protecting the participants' privacy.

Further, the person identification unit 117 may identify, from the image data received from the meeting data acquisition unit 112, the person regarding the image. In this case, the person identification unit 117 associates the face feature information extracted from the face image with the person attribute information stored in the storage unit 120 and identifies the participant who corresponds to the face feature information. Accordingly, the person identification unit 117 is able to identify each of the participants in the meeting. By identifying the participants in the meeting, the analysis apparatus 200 is able to generate analysis data associated with the identified participant. Therefore, the analysis apparatus 200 is able to conduct a detailed analysis on the identified participant.

The analysis data generation unit 113 generates analysis data regarding the meeting based on the emotion data acquired by the emotion data acquisition unit 111. The analysis data includes at least one index (second index) indicating reactions of the participant to the meeting indicating, for example, a level of attention, a level of empathy, a level of understanding and the like. The analysis data generation unit 113 indicates at least one second index indicating the reactions of the participant to the meeting by a numerical value based on the emotion data. The analysis data generation unit 113 generates, for example, a time-series graph showing a temporal transition of the numerical value in the second index as the analysis data. Accordingly, it is possible to indicate detailed changes in the reactions of the participant to the meeting. The analysis data generation unit 113 supplies the generated analysis data to the screen generation unit 114.

The analysis data generation unit 113 further generates, from the received emotion data, the meeting data, and the data indicating the chapters, analysis data in which statistical values (e.g., an average value) of the numerical value in the second index in a predetermined period have been calculated. The predetermined period is a period for each chapter.

The analysis data generation unit 113 supplies the generated analysis data to the screen generation unit 114.

The screen generation unit 114 generates a playback screen output by the output unit 115. The playback screen includes a seek bar for specifying a time, the analysis data at the time specified by the seek bar, and the image data. The screen generation unit 114 extracts the image data of the time specified by the seek bar based on the image data and the time data that is included in the image data, and includes the extracted image data in the playback screen. Further, the screen generation unit 114 generates a playback screen that includes a display for identifying a numerical value in the second index that corresponds to the time specified by the seek bar on the time-series graph. The screen generation unit 114 generates, for example, an axis that corresponds to the time specified in the seek bar on the time-series graph. The axis generated on the time-series graph indicates the second index at the specified time.

The output unit 115 outputs the playback screen generated by the screen generation unit 114 to a user terminal 990. The user who uses the analysis apparatus 100 visually recognizes the playback screen output to the user terminal 990. Accordingly, the user concurrently perceives the analysis data displayed on the playback screen and the meeting image. The user is therefore able to recognize the situation of the meeting and the emotions of the participants in this situation.

The storage unit 120 is a storage apparatus including a non-volatile memory such as a SSD or a flash memory. The storage unit 120 stores the person attribute data and analysis history data. The person attribute data is data in which face feature information of the person is associated with the information regarding the segmentation or the attribute of the person. The information regarding the segmentation or the attribute of the person includes, for example, but not limited to, the name of the person, the sex of the person, the age of the person, the category of the job, the legal entity or the department to which this person belongs. The analysis history data is analysis data regarding the analysis that the analysis apparatus 200 has executed in the past. The storage unit 120 stores, for example, besides the aforementioned data, a program or the like for executing the analysis method according to this example embodiment.

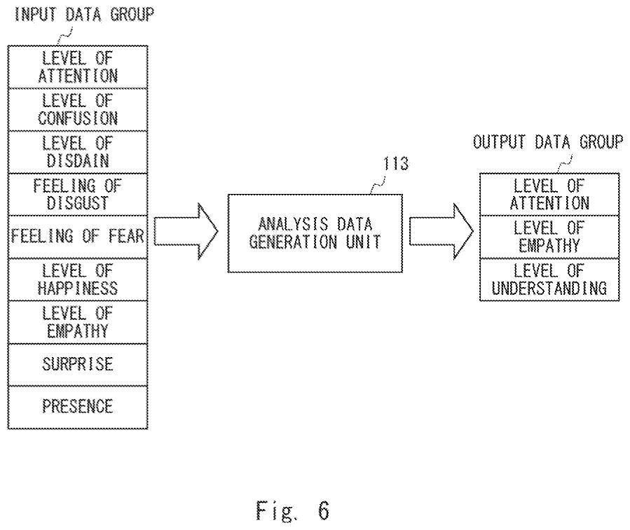

Referring next to FIG. 6, the analysis data generation unit 113 according to the second example embodiment will be further described. FIG. 6 is a diagram showing an example of data processed by the analysis data generation unit according to the second example embodiment. FIG. 6 shows an input data group received by the analysis data generation unit 113 and an output data group output by the analysis data generation unit 113. The analysis data generation unit 113 receives emotion data as the input data group from the emotion data generation apparatus 300. The input data group includes, for example, the first indices regarding a level of attention, a level of confusion, a level of disdain, a feeling of disgust, a feeling of fear, a level of happiness, a level of empathy, surprise, and the presence. These indices are indicated, for example, by numerical values from 0 to 100. The emotion data of the input data group acquired may be the one generated from the face image data using the existing video processing technique or may be generated or acquired by another method.

Upon receiving the aforementioned input data group, the analysis data generation unit 113 performs preset processing and generates an output data group using the input data group. The output data group is data referred to by the user who uses the analysis system 10 in order to efficiently conduct the meeting. The output data group includes, for example, second indices regarding a level of attention, a level of empathy, and a level of understanding. The analysis data generation unit 113 further performs preset computation processing on the values regarding the second indices. Then, the analysis data generation unit 113 generates the aforementioned output data group. The level of attention indicated as the output data group may be the same as the level of attention included in the input data group or may be different from that. Likewise, the level of empathy indicated as the output data group may be the same as the level of empathy included in the input data group or may be different from that.

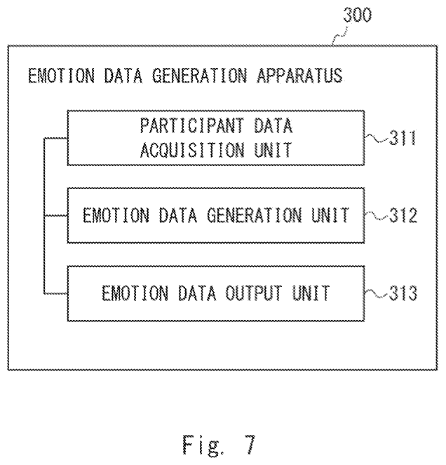

Referring next to FIG. 7, the emotion data generation apparatus 300 according to the second example embodiment will be described. FIG. 7 is a block diagram showing a configuration of the emotion data generation apparatus according to the second example embodiment. The emotion data generation apparatus 300 includes a participant data acquisition unit 311, an emotion data generation unit 312, and an emotion data output unit 313.

The participant data acquisition unit 311 acquires data regarding the participants from the meeting management apparatus 400. The data regarding the participants is face image data of the participants captured by the meeting terminal. The emotion data generation unit 312 generates emotion data from the face image data received by the emotion data generation apparatus 300. The emotion data output unit 313 outputs the emotion data generated by the emotion data generation unit 312 to the analysis apparatus 200 via the network N. The emotion data generation apparatus 300 generates the emotion data by performing predetermined image processing on the face image data of the participants. The predetermined image processing is, for example, extraction of feature points (or feature amount), comparison between the extracted feature points with reference data, convolution processing of image data and processing using machine-learned teaching data, processing using teaching data by deep learning or the like. Note that the method in which the emotion data generation apparatus 300 generates the emotion data is not limited to the aforementioned processing. The emotion data may be numerical values, which are indices indicating emotions, or may include the one including image data used when the emotion data is generated.

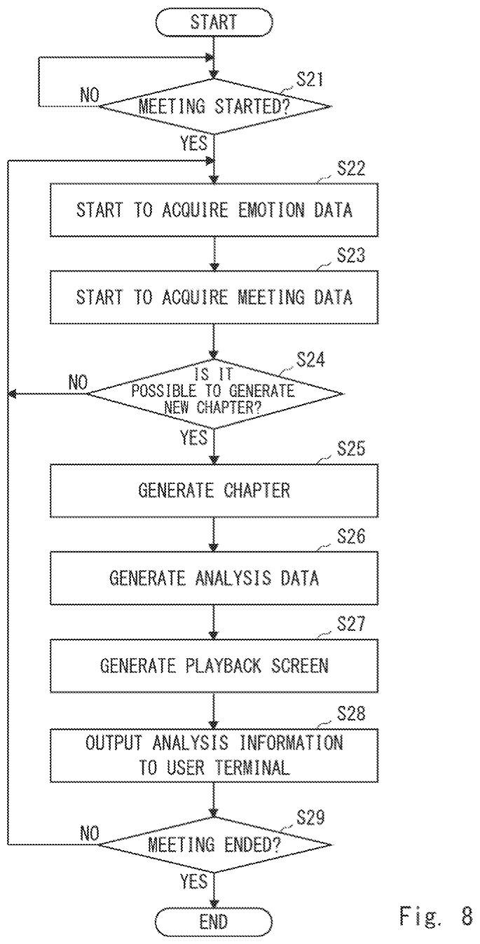

Referring next to FIG. 8, an operation of the analysis apparatus 200 according to the second example embodiment will be described. FIG. 8 is a flowchart showing an operation of the analysis apparatus according to the second example embodiment.

First, the analysis apparatus 200 determines whether or not the online meeting has been started (Step S21). The analysis apparatus 200 determines that the meeting has been started by receiving a signal indicating that the meeting has been started from the meeting management apparatus 400. When it is not determined that the online meeting has been started (Step S21: NO), the analysis apparatus 200 repeats Step S21. When it has been determined that the online meeting has been started (Step S21: YES), the analysis apparatus 200 proceeds to Step S22.

In Step S22, the emotion data acquisition unit 111 acquires the emotion data from the emotion data generation apparatus 300 (Step S22). The emotion data acquisition unit 111 may acquire the generated emotion data every time the emotion data generation apparatus generates the emotion data or may collectively acquire the emotion data at a plurality of different times.

Next, the meeting data acquisition unit 112 acquires meeting data (Step S23). The meeting data includes image data that includes time data of the participants in the meeting. Further, the meeting data includes the start time and the end time of the meeting. The meeting data acquisition unit 112 may receive the meeting data for every predetermined period (e.g., one minute) or may receive the meeting data every time the meeting data includes information that should be updated.

Next, the analysis apparatus 200 determines whether or not it is possible to generate a new chapter (Step S24). Specifically, the analysis apparatus 200 determines whether it is possible to generate a new chapter based on the received meeting data. When it is determined that a new chapter can be generated (Step S24: NO), the analysis apparatus 200 returns to Step S22. On the other hand, when it is possible to generate a new chapter (Step S24: YES), the analysis apparatus 200 returns to Step S25.

In Step S25, the chapter generation unit 116 generates chapters based on the meeting data (Step S25). Specifically, the chapter generation unit 116 generates chapters based on the meeting data.

Next, the analysis data generation unit 113 generates analysis data (Step S26). Specifically, the analysis data generation unit 113 generates analysis data for the newly-generated chapter from the emotion data received from the emotion data acquisition unit 111, the meeting data received from the meeting data acquisition unit 112, the data indicating the chapters received from the chapter generation unit 116, and the data received from the person identification unit 117. Then, upon generating analysis data for each chapter, the analysis data generation unit 113 supplies the generated analysis data to the screen generation unit 114.

Next, the screen generation unit 114 generates a playback screen based on the analysis data (Step S27). Next, the output unit 115 outputs the generated playback screen to the user terminal 990 (Step S28). Further, the analysis apparatus 200 determines whether or not the meeting has ended (Step S29). The analysis apparatus 200 determines that the meeting has ended by receiving a signal indicating that the meeting has ended from the meeting management apparatus 400. When it is not determined that the meeting has ended (Step S29: NO), the analysis apparatus 200 returns to Step S22 and continues the processing. On the other hand, when it is determined that the online meeting has ended (Step S29: YES), the analysis apparatus 200 ends the series of processing.

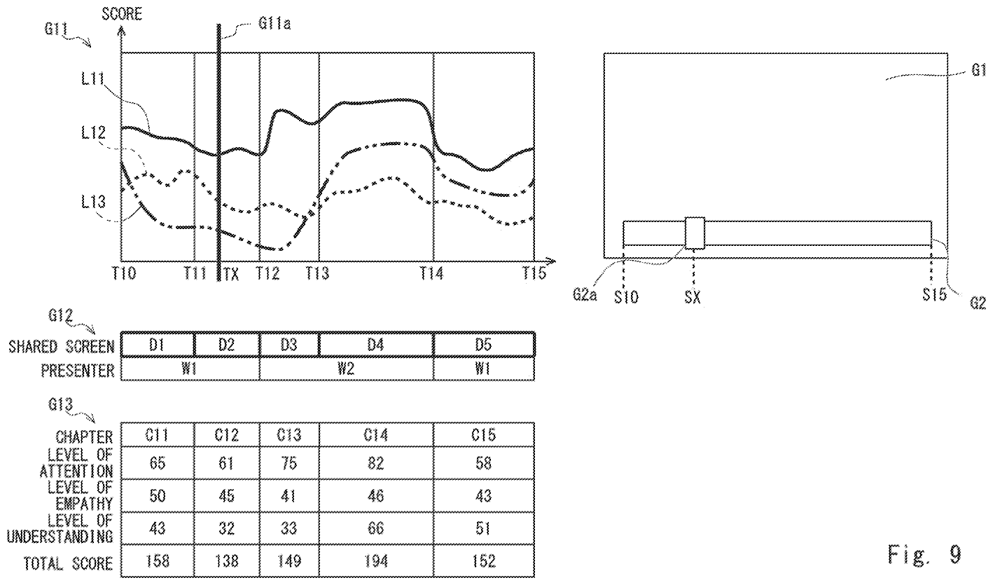

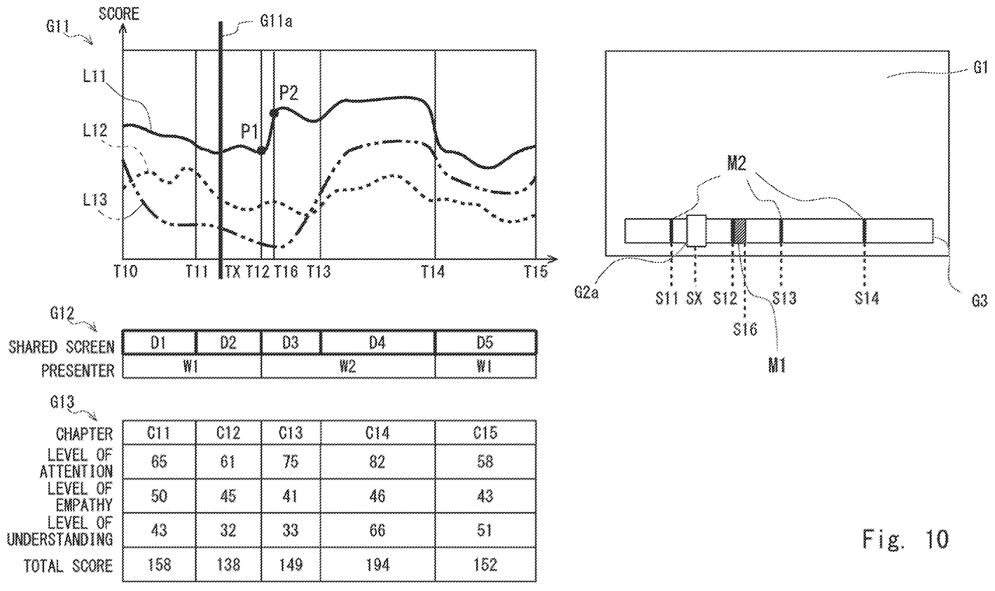

Referring next to FIGS. 9 and 10, examples of the playback screen according to the second example embodiment will be described.

FIG. 9 is a diagram showing a first example of the playback screen according to the second example embodiment. The playback screen shown in

FIG. 9 includes image data G1 showing the analysis data in a time series, a seek bar G2, a graph G11, meeting data G12, and analysis data G13.

The image data G1, which is image data in the meeting, is image data at a time specified by the seek bar G2 that will be described later. The seek bar is superimposed on the image data G1.

The seek bar G2 is an interface for specifying a specific time in the meeting and displaying the specified time. The seek bar G2, which is a strip-shaped image that is extended in the right/left direction, is superimposed, for example, on the meeting screen.

The seek bar G2 includes a slider G2a. The slider G2a, which is a rectangular image arranged on the seek bar G2, specifies a specific position in the seek bar. The user is able to specify the position of the slider G2a by selecting a specific position of the seek bar G2. Accordingly, the image of the time that corresponds to the position specified by the slider G2a is displayed in the image data G1. The user is able to specify the position of the slider G2a by moving the slider G2a in the right/left direction in a state in which the slider G2a is selected.

The graph G11 is a time-series graph showing a temporal transition of the second index. In the graph G11, the horizontal axis indicates time and the vertical axis indicates the numerical value (score) in the second index. The left end of the horizontal axis is time T10, the time elapses as it moves to the right, and the right end is time T15. The time T10 corresponds to the start time of the meeting and time T15 corresponds to the end time of the meeting. The times T11, T12, T13, and T14 between time T10 and time T15 indicate the times that correspond to chapters that will be described later.

Further, in the graph G11, first analysis data L11 shown by a solid line, second analysis data L12 shown by a dotted line, and third analysis data L13 shown by an alternate long and two short dashes line are plotted. The second index is, for example, the level of attention, the level of empathy, or the level of understanding. The first analysis data L11 indicates the level of attention. The second analysis data L12 indicates the level of empathy. The third analysis data L13 indicates the level of understanding.

An axis G11a, which is a linear display that is extended in the vertical direction, crossing the horizontal axis of the graph G11, indicates a specific time of the graph G11. The axis G11a moves on the horizontal axis of the graph G11 and shows time TX specified by the seek bar G2. That is, the position of the seek bar G2 and the position of the axis G11a are associated with each other. The seek bar G2 and the axis G11a may be the ones displayed by color tones in accordance with the value of the analysis data in the specified position. Accordingly, the analysis apparatus 100 is able to qualitatively show the state of the emotion at the time specified in the meeting image. The user is therefore able to intuitively know the state of the emotion at a specific time. In this example, the position S10 of the seek bar G2 in the left end corresponds to the time T11 and the position S15 of the seek bar G2 in the right end corresponds to time T15. The relative right/left position of the slider G2a in the seek bar G2 is set so as to correspond to the relative right/left position of the axis G11a in the graph G11. When, for example, the slider G2a is present in a position SX, the axis G11a crosses the time TX in the horizontal axis in the graph G11. At this time, the ratio of the length from the position SX to the position S10 to the length from the position S15 to the position SX is the same as the ratio of the length from time TX to time T10 to the length from time T15 to time TX. When the user moves the position of the slider G2a, the position of the axis G11a also moves along with the movement of the position of the slider G2a. When the user moves the position of the axis G11a, the position of the slider G2a may move along with the movement of the position of the axis G11a.

The user is able to move the position of the slider G2a on the playback screen output by the output unit 115. Upon detecting the movement of the position of the slider G2a, the analysis apparatus 100 detects the time specified by the seek bar G2 based on the relative right/left position of the slider G2a after the movement. The screen generation unit 114 generates a playback screen including the image data G1 based on the detected time. Then the screen generation unit 114 generates a playback screen including the axis G11a in which the relative right/left position is determined on the graph G11 based on the detected time. The output unit 115 then outputs the generated playback screen. Further, the user is able to move the position of the axis G11a in the graph G11 on the playback screen output by the output unit 115. Upon detecting the movement of the position of the axis G11a, the analysis apparatus 100 detects the time specified by the axis G11a based on the relative right/left position of the axis G11a after the movement. The screen generation unit 114 generates a playback screen including the image data G1 based on the detected time. Then the screen generation unit 114 generates a playback screen including the seek bar G2 in which the relative right/left position of the slider G2a is determined based on the detected time. The output unit 115 then outputs the generated playback screen.

The meeting data G12 shows data regarding the shared screen of the meeting and data regarding the presenter in a time series. That is, data regarding the display screen indicates that the shared screen from time T10 to time T11 has been a screen D1. Further, the data regarding the display screen indicates that the shared screen from time T11 to time T12 has been a screen D2. Likewise, the meeting data G12 indicates that the shared screen in the meeting has been a screen D3 from time T12 to time T13, a screen D4 from time T13 to time T14, and a screen D5 from time T14 to time T15.

Further, in the meeting data G12, the data regarding the presenter indicates that the presenter has been a presenter W1 from time T10 to time T12. Likewise, the data regarding the presenter indicates that the presenter has been a presenter W2 from time T12 to time T14 and that the presenter has been the presenter W1 again from time T14 to time T15.

The relation between the shared screen and the presenter in the aforementioned meeting data G12 will be described in a time series. The presenter W1 proceeds with the meeting from time T10 when the meeting has been started to time T12 and the presenter W1 has displayed the screen D1 as a shared screen (i.e., share the screen D1) from time T10 to time T11. Next, the presenter W1 has continued the presentation after switching the shared screen from the screen D1 to the screen D2 from time T11 to time T12. Next, at time T12, the presenter has been switched from the presenter W1 to the presenter W2. The presenter W2 has shared the screen D3 between time T12 and time T13 and shared the screen D4 between time T13 and time T14. In the period between time T14 and time T15, the presenter W1 switched from the presenter W2 has shared the screen D5.

The relation between the shared screen and the presenter in the meeting data G12 has been described above in a time series. As described above, the meeting data shown in FIG. 9 includes data regarding the period during which the screen data is displayed on the shared screen and data indicating who the presenter is. The chapter generation unit 116 is able to generate chapters in accordance with data regarding the shared screen of the aforementioned meeting data.

The analysis data G13 shows data indicating chapters that correspond to the aforementioned meeting data and the analysis data that corresponds to the chapters in a time series. In the example shown in FIG. 9, data indicating chapters corresponds to data regarding the shared screen of the meeting data. That is, the first chapter C11 is a period from time T10 to time T11 during which the screen D1 has been shared. Likewise, the second chapter C12 is a period from time T11 to time T12 during which the screen D2 has been shared. The third chapter C13 is a period from time T12 to time T13 during which the screen D3 has been shared. The fourth chapter C14 is a period from time T13 to time T14 during which the screen D4 has been shared. The fifth chapter C15 is a period from time T14 to time T15 during which the screen D5 has been shared.

The analysis data G13 includes statistical values of the numerical value in the second index for each chapter. The analysis data indicates, for example, statistical values in the second index (the level of attention, the level of empathy, or the level of understanding) for each chapter, and the total score obtained by summing up the above statistical values. The analysis data G13 shows, for example, that the level of attention is 65, the level of empathy is 50, and the level of understanding is 43 in the chapter C11. Further, the analysis data G13 shows 158 as the total score. Likewise, in the chapter C12, for example, the level of attention is 61, the level of empathy is 45, the level of understanding is 32, and the total score is 138.

The analysis data G13 corresponds to data plotted in the graph G11. That is, the analysis data shown as the analysis data G13 is an average value of the analysis data calculated for each predetermined period (e.g., one minute) in the period of the corresponding chapter.

While the timing when the shared screen is switched in the meeting data is set as the timing when the chapter is switched in the analysis apparatus 200, the timing when the presenter (W1, W2, or W3) is switched in the meeting data may be set as the timing when the chapter is switched. Accordingly, the analysis apparatus 200 is able to provide a statistical value for each presenter.

In the analysis apparatus 200 according to the second example embodiment, the user is able to check the image data at a desired timing of the meeting by moving the slider G2a of the seek bar G3 on the playback screen. The position of the axis G11a in the horizontal axis of the graph G11 corresponds to the time specified by the seek bar G3. Therefore, the user is able to instantly know the tendency of the emotions of the participants in the meeting at the timing when the image data in the meeting is checked by checking the position of the axis G11a in the graph G11. Therefore, with the analysis apparatus 100, it is possible to know what the emotions of the participants in the meeting are.

Further, in the analysis apparatus 200, the statistical value of the numerical value in the second index for each chapter is included in the playback screen. Therefore, the user is able to quantitatively and instantly know what the emotions of the participants in the meeting are at the timing when the image data in the meeting is checked based on the position of the axis G11a.

Referring next to FIG. 10, a second example of the playback screen according to the second example embodiment will be described. FIG. 10 is a diagram showing a second example of the playback screen according to the second example embodiment. In FIG. 10, the image data G1, the graph G11, the meeting data G12, and the analysis data G13 are the same as those shown in FIG. 9.

A seek bar G3 displays a timing when the score of the analysis data in the graph G11 has been changed by a predetermined value in such a way that the user is able to identify this timing. In this example, when the score of the analysis data L11 has been changed from time T12 (point P1) to time T16 (point P1) by a predetermined value, the seek bar G2 displays a mark M1 between the position S12 that corresponds to the time T12 and the position S16 that corresponds to the time T16. While the mark M1 is displayed between the position S12 and the position S16 of the seek bar G3 in this example, the mark M1 may be displayed in a predetermined position between the position S12 and the position S16 of the seek bar G3.

Accordingly, the user is able to move the slider G2a using the mark M1 of the seek bar G3 as a landmark on the playback screen. Then the user can check the image data that corresponds to the mark M1 (i.e., at a timing when the emotion of the participant has been significantly changed). Further, by checking the position of the axis G11a in the graph G11, the user is able to instantly know the tendency of the emotion in the meeting at the timing when the emotion of the participant has been significantly changed.

Further, the seek bar G3 displays the timing when each chapter is switched in the analysis data G13 in such a way that the user is able to identify this timing. In this example, the chapters are switched at time T11, at time T12, at time T13, and at time T14. Here, the position S11, the position S12, the position S13, and the position S14 of the seek bar G3 respectively correspond to the time T11, the time T12, the time T13, and time the T14. Then the seek bar G3 displays the mark M2 in the position S11, the position S12, the position S13, and the position S14. While the mark M2 is displayed in each of the positions of the seek bar G3 (the position S11, the position S12, the position S13, and the position S14) in this example, it may be displayed in any one of these positions.

Therefore, the user is able to move the slider G2a using the mark M2 of the seek bar G3 as a landmark on the playback screen. Then, the user is able to check the image data that corresponds to the mark M2 (i.e., at a timing when the chapter is switched). Further, by checking the position of the axis Glia in the graph G11, the user is able to instantly know the tendency of the emotion in the meeting at the timing when the chapter is switched.

### Example of Hardware Configuration

Each functional configuration unit of the analysis apparatus 100, the analysis apparatus 200, the emotion data generation apparatus 300, and the meeting management apparatus 400 (hereinafter they will be referred to as “each apparatus”) may be implemented with hardware (e.g., a hardwired electronic circuit) that implements each functional configuration unit or by a combination of hardware with software (e.g., a combination of an electronic circuit with a program that controls the electronic circuit). Hereinafter, a case in which each functional configuration unit of each apparatus is implemented with a combination of hardware with software will be further described.

FIG. 13 is a block diagram illustrating a hardware configuration of the computer. Each of the apparatuses may be implemented by a computer 500 including a hardware configuration shown in FIG. 13. The computer 500 is a portable computer such as a smartphone or a tablet terminal. The computer 500 may be a portable computer or may be a stationary computer such as a PC. The computer 500 may be a special-purpose computer that is designed to implement each of the apparatuses or may be a general-purpose computer. Further, the computer 500 may be a stationary computer such as a Personal Computer (PC).

For example, by installing a specific application in the computer 500, a desired function may be implemented in the computer 500. For example, by installing an application for implementing each function of each apparatus into the computer 500, each function of each apparatus is implemented by the computer 500.

The computer 500 includes a bus 502, a processor 504, a memory 506, a storage device 508, an input/output interface 510, and a network interface (I/F) 512. The bus 502 is a data transmission path for enabling the processor 504, the memory 506, the storage device 508, the input/output interface 510, and the network interface 512 to transmit and receive data among them. However, the method for connecting the processor 504 and the like to one another is not limited to the bus connection.

The processor 504 may be any type of processor such as a Central Processing Unit (CPU), a Graphics Processing Unit (GPU), or a Field-Programmable Gate Array (FPGA). The memory 506 is a main memory unit that is implemented using a Random Access Memory (RAM) or the like. The storage device 508 is an auxiliary storage device that is implemented with a hard disk, a Solid State Drive (SSD), a memory card, or a Read Only Memory (ROM).

The input/output interface 510 is an interface for connecting the computer 500 to an input/output device. An input device such as a keyboard and an output device such as a display device are connected, for example, to the input/output interface 510.

The network interface 512 is an interface for connecting the computer 500 to a network. This network may be a Local Area Network (LAN) or a Wide Area Network (WAN).

The storage device 508 stores a program for achieving a desired function. The processor 504 loads this program into the memory 506 to execute the loaded program, thereby implementing each functional configuration unit of each apparatus.

Note that the present invention is not limited to the aforementioned example embodiments and may be changed as appropriate without departing from the spirit of the present invention.

For example, the analysis system 10 may include a meeting management apparatus 400. In this case, the analysis apparatus 200, the emotion data generation apparatus 300, and the meeting management apparatus 400 may be provided separately from one another or some or all of them may be integrated. Further, for example, the function that the emotion data generation apparatus 300 includes may be formed as a program and included in the analysis apparatus 200 or the meeting management apparatus 400.

Further, the layout of the playback screen according to the aforementioned example embodiments is not limited to the examples shown in the aforementioned example embodiments. For example, the graph Gil in the playback screen shown in FIG. 3 may be provided in a lower part of the image data Gl. Further, the seek bar G2 in the playback screen shown in FIG. 3 may not be superimposed on the image data G1 and may be provided in another place.

In the aforementioned examples, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-Read Only Memory (ROM), CD-R, CD-R/W, semiconductor memories (such as mask ROM, Programmable ROM (PROM), Erasable PROM (EPROM), flash ROM, Random Access Memory (RAM), etc.). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The whole or part of the example embodiments disclosed above can be described as, but not limited to, the following supplementary notes.

### Supplementary Note 1

An analysis apparatus comprising:

emotion data acquisition means for acquiring emotion data that includes time data, the emotion data being generated based on face image data of participants in an online meeting;

meeting data acquisition means for acquiring meeting data including image data that includes time data in the meeting;

analysis data generation means for generating analysis data regarding the meeting based on the emotion data;

screen generation means for generating a playback screen including a seek bar for specifying a time, the analysis data that corresponds to the specified time, and the image data; and

output means for outputting the playback screen.

### Supplementary Note 2

The analysis apparatus according to Supplementary Note 1, wherein the emotion data acquisition means acquires a first index in which a state of an emotion based on the face image data is indicated by at least one numerical value as the emotion data.

### Supplementary Note 3

The analysis apparatus according to Supplementary Note 1 or 2, wherein the analysis data generation means indicates at least one second index indicating reactions of the participants to the meeting by a numerical value based on the emotion data, and

the analysis data generation means generates a time-series graph showing a temporal transition of the second index as the analysis data.

### Supplementary Note 4

The analysis apparatus according to Supplementary Note 3, wherein the screen generation means generates the playback screen in which a display indicating the second index that corresponds to the time specified by the seek bar is included in the time-series graph.

### Supplementary Note 5

The analysis apparatus according to Supplementary Note 4, wherein the screen generation means generates the playback screen in which an axis for identifying the numerical value in the second index that corresponds to the time specified by the seek bar is included in the time-series graph.

### Supplementary Note 6

The analysis apparatus according to Supplementary Note 5, wherein

the screen generation means generates a slider for specifying a time based on a relative position in the seek bar, and

the slider is associated with a relative position of the axis on the time-series graph.

### Supplementary Note 7

The analysis apparatus according to any one of Supplementary Notes 3 to 6, wherein the screen generation means generates the playback screen including the seek bar indicating a time when the second index has been changed within a predetermined range and a predetermined period.

### Supplementary Note 8

The analysis apparatus according to any one of Supplementary Notes 3 to 7, wherein the analysis data generation means generates the analysis data by calculating a statistical value of a numerical value in the second index in a predetermined period.

### Supplementary Note 9

The analysis apparatus according to any one of Supplementary Notes 1 to 8, further comprising chapter generation means for generating chapters for the meeting based on the meeting data, wherein

the screen generation means generates the playback screen including the seek bar indicating a time when the chapter is switched.

### Supplementary Note 10

The analysis apparatus according to any one of Supplementary Notes 1 to 9, further comprising chapter generation means for generating chapters for the meeting based on the meeting data, wherein

the analysis data generation means generates the analysis data based on the emotion data for each of the chapters.

### Supplementary Note 11

The analysis apparatus according to Supplementary Note 9 or 10, wherein

the meeting data acquisition means acquires meeting data including data regarding screen sharing in the meeting, and

the chapter generation means generates the chapters based on the data regarding the screen sharing.

### Supplementary Note 12

The analysis apparatus according to Supplementary Note 11, wherein the chapter generation means generates the chapter based on a timing when the screen sharing is switched.

### Supplementary Note 13

The analysis apparatus according to Supplementary Note 11, wherein the chapter generation means generates the chapter in accordance with a time when the owner of the shared screen in the screen sharing is switched.

### Supplementary Note 14

The analysis apparatus according to any one of Supplementary Notes 1 to 13, further comprising person identification means for identifying a person based on face image data, wherein

the meeting data acquisition means acquires face image data of the participants,

the person identification means identifies segmentation to which the participant belongs from the face image data, and

the analysis data generation means generates the analysis data in view of the segmentation.

### Supplementary Note 15

The analysis apparatus according to any one of Supplementary Notes 1 to 14, further comprising person identification means for identifying a person based on face image data, wherein

the meeting data acquisition means acquires face image data of the participants,

the person identification means identifies the participants from the face image data, and

the analysis data generation means generates the analysis data of the participants regarding the identification.

### Supplementary Note 16

An analysis system comprising:

the analysis apparatus according to any one of Supplementary Notes 1 to 15; and

an emotion data generation apparatus configured to generate the emotion data and provides the emotion data for the analysis apparatus.

### Supplementary Note 17

A method comprising:

acquiring emotion data that includes time data, the emotion data being generated based on face image data of participants in an online meeting;

acquiring meeting data including image data that includes time data in the meeting;

generating analysis data regarding the meeting based on the emotion data;

generating a playback screen including a seek bar for specifying a time, the analysis data that corresponds to the specified time, and the image data; and
outputting the playback screen.

### Supplementary Note 18

A non-transitory computer readable medium storing a program for causing a computer to execute the following processing of:

acquiring emotion data that includes time data, the emotion data being generated based on face image data of participants in an online meeting;

acquiring meeting data including image data that includes time data in the meeting;

generating analysis data regarding the meeting based on the emotion data;

generating a playback screen including a seek bar for specifying a time, the analysis data that corresponds to the specified time, and the image data; and

outputting the playback screen.

### REFERENCE SIGNS LIST

10 Analysis System
90 Meeting Terminal Group
100 Analysis Apparatus
111 Emotion Data Acquisition Unit
112 Meeting Data Acquisition Unit
113 Analysis Data Generation Unit
114 Screen Generation Unit
115 Output Unit
116 Chapter Generation Unit
117 Person Identification Unit
120 Storage Unit
200 Analysis Apparatus
300 Emotion Data Generation Apparatus
311 Participant Data Acquisition Unit
312 Emotion Data Generation Unit
313 Emotion Data Output Unit
400 Meeting Management Apparatus
500 Computer
502 Bus
504 Processor
506 Memory
508 Storage Device
510 Input/Output Interface (I/F)
512 Network Interface (I/F)
900, 900A, 900B Meeting Terminal
990 User Terminal

What is claimed is:

1. An analysis apparatus comprising:
at least one memory acquiring storing instructions and
at least one processor configured to execute the instructions to:
acquire emotion data that includes time data, the emotion data being generated based on face image data of participants in an online meeting;
acquire meeting data including image data that includes time data in the meeting;
generate analysis data regarding the meeting based on the emotion data;
generate a playback screen including a seek bar for specifying a time, the analysis data that corresponds to the specified time, and the image data; and
output the playback screen.

2. The analysis apparatus according to claim 1, wherein the at least one processor is further configured to execute the instructions to acquire a first index in which a state of an emotion based on the face image data is indicated by at least one numerical value as the emotion data.

3. The analysis apparatus according to claim 1, wherein the at least one processor is further configured to execute the instructions to:
indicate at least one second index indicating reactions of the participants to the meeting by a numerical value based on the emotion data, and
generate a time-series graph showing a temporal transition of the second index as the analysis data.

4. The analysis apparatus according to claim 3, wherein the at least one processor is further configured to execute the instructions to generate the playback screen in which a display indicating the second index that corresponds to the time specified by the seek bar is included in the time-series graph.

5. The analysis apparatus according to claim 4, wherein the at least one processor is further configured to execute the instructions to generate the playback screen in which an axis for identifying the numerical value in the second index that corresponds to the time specified by the seek bar is included in the time-series graph.

6. The analysis apparatus according to claim 5, wherein
the at least one processor is further configured to execute the instructions to generate a slider for specifying a time based on a relative position in the seek bar, and
the slider is associated with a relative position of the axis on the time-series graph.

7. The analysis apparatus according to claim 3, wherein the at least one processor is further configured to execute the instructions to generate the playback screen including the seek bar indicating a time when the second index has been changed within a predetermined range and a predetermined period.

8. The analysis apparatus according to claim 3, wherein the at least one processor is further configured to execute the instructions to generate the analysis data by calculating a statistical value of a numerical value in the second index in a predetermined period.

9. The analysis apparatus according to claim 1, further comprising the at least one processor is further configured to execute the instructions to generate chapters for the meeting based on the meeting data, wherein
the at least one processor is further configured to execute the instructions to generate the playback screen including the seek bar indicating a time when the chapter is switched.

10. The analysis apparatus according to claim 1, further comprising the at least one processor is further configured to execute the instructions to generate chapters for the meeting based on the meeting data, wherein
the at least one processor is further configured to execute the instructions to generate the analysis data based on the emotion data for each of the chapters.

11. The analysis apparatus according to claim 9, wherein the at least one processor is further configured to execute the instructions to:
acquire meeting data including data regarding screen sharing in the meeting, and
generate the chapters based on the data regarding the screen sharing.

12. The analysis apparatus according to claim 11, wherein the at least one processor is further configured to execute the instructions to generate the chapter based on a timing when the screen sharing is switched.

13. The analysis apparatus according to claim 11, wherein the at least one processor is further configured to execute the instructions to generate the chapter in accordance with a time when the owner of the shared screen in the screen sharing is switched.

14. The analysis apparatus according to claim 1, further comprising the at least one processor is further configured to execute the instructions to identify a person based on face image data, wherein
the at least one processor is further configured to execute the instructions to:
acquire face image data of the participants,
identify segmentation to which the participant belongs from the face image data, and
generate the analysis data in view of the segmentation.

15. The analysis apparatus according to claim 1, further comprising the at least one processor is further configured to execute the instructions to identify a person based on face image data, wherein
the at least one processor is further configured to execute the instructions to:
acquire face image data of the participants,
identify the participants from the face image data, and
generate the analysis data of the participants regarding the identification.

16. (canceled)

17. A method comprising:
acquiring emotion data that includes time data, the emotion data being generated based on face image data of participants in an online meeting;
acquiring meeting data including image data that includes time data in the meeting;
generating analysis data regarding the meeting based on the emotion data;
generating a playback screen including a seek bar for specifying a time, the analysis data that corresponds to the specified time, and the image data; and
outputting the playback screen.

18. A non-transitory computer readable medium storing a program for causing a computer to execute the following processing of:
acquiring emotion data that includes time data, the emotion data being generated based on face image data of participants in an online meeting;
acquiring meeting data including image data that includes time data in the meeting;
generating analysis data regarding the meeting based on the emotion data;
generating a playback screen including a seek bar for specifying a time, the analysis data that corresponds to the specified time, and the image data; and
outputting the playback screen.
